(19) United States
(12) Patent Application Publication
(10) Pub. No.: US 2004/0237260 A1
(43) Pub. Date: Dec. 2, 2004

(54) Method for granulating concertrated solutions, especially for producing fertilising agent, and granulator for carrying out the method

(76) Inventor: Eugen Leopold, Dortmund (DE)

Correspondence Address: WILLIAM COLLARD, COLLARD & ROE, P.C., 1077 NORTHERN BOULEVARD, ROSLYN, NY, 11576, US

(21) Appl. No.: 10/486,859

(22) PCT Filed: Jul. 27, 2002
(86) PCT No.: PCT/EP02/08407

(30) Foreign Application Priority Data
Aug. 16, 2001 (DE) 101 40 139.6

(51) Int. Cl. C05B 19/00

(52) U.S. Cl. 23/313 R; 264/5; 425/6

(57) ABSTRACT

With the help of a method for granulating concentrated solutions. particularly for fertilizer production. granulates of reproduceable grain size with a high degree of effectiveness of the trough mixer used. is supposed to be created.

This is achieved, in that the material to be treated is mechanically fluidised by the rotating impact blades. whereby a fused version of the product to be granulated is sprayed-on over the length of the treatment trough through feed nozzles to the generated particles-bed.

The invention pertains to a method for granulation of concentrated solutions, especially for fertilizer production, by using a granulator with several impact blades arranged on at least one shaft set in the desired feed direction, whereby the shaft rotates in a trough, with an inlet at the beginning of the trough for the material to be treated and an outlet at the end of the trough for removing the produced granulate, as well as with entry nozzles for feeding of fluid into the trough.

Such a method is known, for example, from the document US-3 825 414, whereby design details of the trough mixers used here are known from the Japanese abstract JP 9-277 244, in which twin shafts rotate with impact blades. Also in “Ull'manns Encyclopedia of Industrial Chemistry”. 5^{th} edition, vol. A 10. pages 376 ff, such impact mills or trough mixers are known. In such devices, a fused material is introuduced from one side of the trough and mixed in the interior. whereby through the movement and by addition of fluid, the particles adhere to one another or get baked together. Granulation should be understood in this context as an enlargement of particles.

It is the task of the invention to achieve reproduceable granulates with optimum grain size with a high degree of effectiveness.

This task is fulfilled with the help of a method as already described above, in that the material to be treated is mechanically fluidised by means of the rotating impact blade, whereby over the length of the treatment trough, a fused material of the product to be granulated is sprayed on to the generated particles-bed through feed nozzles.

In this method it is achieved, that the impact blades of the granulator are used for generating a fluidised particles-bed in a mechanical manner, whereby the material transportation in axial direction right through the granulator is ensured at the same time. By distributing the feed nozzles over the length of the trough. fluid can be fed in a very specific manner, whereby in this case a fusion of the product is fed in a special way. In this way. it is possible to continuously enlarge the initial small particles and build them up into granulates, which will have the desired size for extraction. The particles collide in the moving bed. whereby with the help of the sprayed-in fluid they get enlarged. adhere to one another or get mixed together.

Extensions of the invention are obtained from the sub-claims. whereby particularly also a granulator for fulfilling the desired task is foreseen, which has the feature of the impact blade mechanically fluidising the material to be treated, as well as feed nozzles over the length of the treatment trough for spraying a fused substance of the product to be granulated on the generated particles-bed.

It is advantageous to feed the fused material through spray nozzles as droplets mist to the particles-bed, as similarly foreseen in an extension of the invention, whereby the fused material can be sprayed mainly vertically from the top through one, two or more rows of nozzles on to the particles-bed. By spraying-on the fused material it is possible to attain a largely homogeneous product, according to the method as per the invention, one can also prevent the tendency of agglutination.

Further features, details and advantages of the invention can be obtained from the basis of the following description as well as on the basis of the drawings. The following are shown:

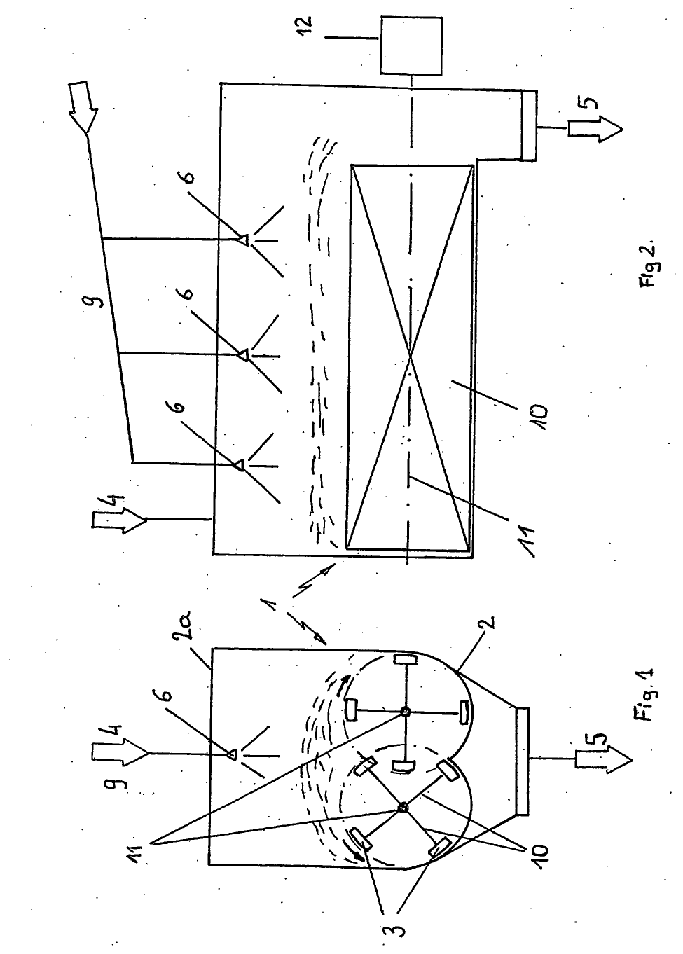

FIG. 1 A worm granulator or trough mixer as per the invention in side view, as twin shaft device; and

FIG. 2 A principle view of a worm granulator in section.

The worm granulator denoted with 1 generally in FIGS. 1 and 2 is a twin shaft worm granulator, whereby the invention is not only restricted to this design.

The worm granulator 1 shown has a housing whose bottom part is mainly designed as a long stretched trough 2 with U-shaped cross-section. The housing cover 2a lies above on the edge of the trough 2 and closes it tightly. The interior of the housing is transported over the entire length of the housing by two horizontally arranged shafts 11 supported in the housing 2.

During operation. the shafts 11 are brought into rotation by means of a drive 12. Each shaft 11 is provided with arms 10. whose centre axis is vertical to the rotation axis of the shaft.

On the outer end of the each arm 10. a scraper blade 3 is fixed. All arms 10 are equally long, while operating the worm granulator 1. the outer contours of the scraper blade 3 move on a covered cylindrical surface encompassing them.

The inner surface of the floor bottom side of the trough 2 surrounds the cylinder surface at a distance of the manufacturing tolerances. which have to be maintained for contact-free running of the scraper blades 3. whereas the rising side walls of the trough 2 are finished plane and largely deviates back from the cylinder surface.

The arms 10 are fastened in the shaft longitudinal direction in such a way on the shaft 11 that the free ends of the arms 10 come to rest on a covered helix. The scraper blades 3 are slightly aligned to the level of the rotation paths covered by them.

By means of a feeding stud 4 the fine material and/or the recycled material is fed to the worm granulator 1, and the treated product is removed by means of a discharge stud 5. On account of this arrangement of the scraper blade 3. the fragmented particles of the material being treated in the trough 2 get pushed in longitudinal direction of the trough: at the same time however. the particles within the heaping mechanism are rotated by the scraper blades and thoroughly mixed. Above all. even vertically moving components are pressed on to the particles.

The worm granulator 1 as per the invention. in which a particles-bed is transported through with a determinable dwelling time duration and whereby the bed is at the same time intensively thoroughly mixed. is particularly suitable to form enlarged granulates from the initially small particles. by adding fluid to the initial bed. In the moving bed the particles collide and with the help of the fluid get adhered to one another or are mixed together. In this invention the enlarging effect is intensified. in that a fused version of the material to be treated is sprayed on to the bed from the top. The fused material is fed to the worm granulator 1 as per the invention through the distribution pipeline 9. Fused material nozzles 6 are attached in the interior of the trough 2. Through their nozzle opening. the fused material is sprayed as droplet mist on to the bed. The two dash-dotted lines in FIG. 1 indicating circles represent the path of the outer contours of the scraper blades 3.

A special extension of the invention is obtained. if the fused material nozzles 6 or 8 spray vertically downwards between the circular paths of the scraper blades 3 directly on to the particles-bed. FIG. 1 shows such arranged fusion material nozzles 6.

The shafts 11. the arms 10 and the scraper blades 3 can be provided with core holes. which serve as guides for heating or cooling agents. These are similarly brought into play like the trough-shaped housing bottom part for heating or cooling of the particles-bed. whereby the housing is fitted with an outer jacket guiding a heating or cooling agent.

1. Method for granulation of concentrated solutions, especially for fertilizer produciton, by using a granulator with several impact blades arranged on at least one shaft set in the desired feeding direction, whereby the shaft rotates in a trough, with an inlet at the beginning of a trough for the material to be treated and an outlet at the end of the trough for remving the produced granulate, as well as entry nozzles for entry of fluid into the trough,
in which
the material to be treated is mechanically fluidised by rotating impact blades, wehreby a fused version of the product to be granulated is sprayed-on over the length of the treatment trough through feed nozzles to the generated particles-bed.

2. Method as per claim 1,
in which
the fused material is fed to the particle bed through the spring nozzles as droplet mist.

3. Method as per claim 1,
in which
the fused material is sprayed-on through the spraying nozzles mainly vertically downwards on to the particles-bed.

4. Trough mixer for carrying out the method as per claim 1,
in which
the material to be treated is mechanically fluidised by the impact blades (3) and there are feed nozzles (6) over the length of the treatment trought (2) for spraying-on a fused veriosn of the product to be grnulated on to the generated particles-bed.

5. Trough mixer as per claim 4,
in which
there are spray nozzles (6) generating droplet mist over the length of the trough.

6. Trough mixer as per claim 4,
in which
there are one, two or more rows of spray nozzles (6) directed to the generated particles-bed.

7. Trough mixer as per claim 4,
in which
the spray nozzles (6) are mainly vertical and directed downwards between the rotating paths of the impact blades (3).
